(19) United States
(12) Patent Application Publication
(10) Pub. No.: US 2026/0222734 A1
(43) Pub. Date: Jul. 30, 2026

(54) SPEAKER DEVICE

(71) Applicant: PANASONIC INTELLECTUAL PROPERTY MANAGEMENT., LTD, Osaka (JP)

(72) Inventors: Katsushi TAMAI, Osaka (JP); Kazutaka GOTO, Kyoto (JP); Kenya TOMITA, Osaka (JP); Kohei MATSUDA, Osaka (JP); Yosuke YOSHIMI, Osaka (JP)

(21) Appl. No.: 19/146,162

(22) PCT Filed: Apr. 4, 2024
(86) PCT No.: PCT/JP2024/013896

§ 371 Date: Jul. 7, 2025

(30) Foreign Application Priority Data
Jul. 31, 2023 (JP) 2023-124280

(51) Int. Cl. H04R 3/04; G10K 11/175; H04R 1/02; H04R 1/28; H04R 1/30; H04R 1/34; H04R 3/12

(52) U.S. Cl. CPC H04R 3/04; G10K 11/1752; H04R 1/025; H04R 1/288; H04R 1/30; H04R 1/345; H04R 3/12; H04R 2430/01

(57) ABSTRACT

A speaker device includes: a signal processing circuit that performs signal processing on a first sound signal, and generates a first output signal and a second output signal; a first loudspeaker that outputs a first sound that is based on the first output signal in a first direction; and a second loudspeaker that outputs a second sound that is based on the second output signal. The signal processing circuit includes a first filter and a second filter. The first filter and the second filter have filter characteristics for adjusting a phase and an amplitude per frequency of the signal input so as to cause a sound pressure of a sound based on the first sound signal at a second position to be lower than a sound pressure of the sound based on the first sound signal at a first position by a predetermined value or more.

### TECHNICAL FIELD

The present invention relates to a speaker device.

### BACKGROUND ART

Conventionally, a directional loudspeaker is known that emits a sound in a specific direction and reduces the sound pressure of the sound at positions in directions other than the specific direction.

For example, Patent Literature (PTL) 1 discloses a technique for implementing sound directivity by using two loudspeakers that emit audio signals of opposite phases and delaying the time at which one of the two loudspeakers emits its audio signal according to the distance between the two loudspeakers.

### CITATION LIST

### Patent Literature

### [PTL 1]

PTL 1: Japanese Unexamined Patent Application Publication No. 2013-33104

### SUMMARY OF INVENTION

### Technical Problem

The present disclosure provides a speaker device that has directivity for sounds in a wide frequency range.

### Solution to Problem

A speaker device according to one aspect of the present disclosure includes: a signal processing circuit that performs signal processing on a first sound signal that is input, and generates a first output signal and a second output signal; a first loudspeaker that outputs a first sound that is based on the first output signal in a first direction; a first horn that emits, in the first direction, the first sound output from the first loudspeaker; and a second loudspeaker that is provided at a position in a second direction relative to the first loudspeaker, and outputs a second sound that is based on the second output signal, the second direction being a direction opposite to the first direction, wherein the signal processing circuit includes a first filter and a second filter that perform the signal processing on, out of the first sound signal, a signal in at least a portion of frequency bands, the first output signal is generated based on an output of the first filter, the second output signal is generated based on an output of the second filter, the first filter and the second filter have filter characteristics for adjusting a phase and an amplitude per frequency of the signal in at least the portion of the frequency bands out of the first sound signal to cause a sound pressure of a sound based on the first sound signal at a second position to be lower than a sound pressure of the sound based on the first sound signal at a first position by a predetermined value or more as a result of the first sound and the second sound overlapping each other, the first position is located in front of the first loudspeaker in the first direction, and the second position is located in a direction at a predetermined angle relative to the first speaker, the predetermined angle being an angle formed with respect to the first direction.

### Advantageous Effects of Invention

According to the present disclosure, it is possible to provide a speaker device that has directivity for sounds in a wide frequency range.

### BRIEF DESCRIPTION OF DRAWINGS

FIG. 1 is a plan view showing one example of an external appearance of a speaker device according to an embodiment.

FIG. 2 is a block diagram showing one example of a functional configuration of the speaker device according to the embodiment.

FIG. 3 is a diagram illustrating a method for designing the filter characteristics of a first FIR filter and a second FIR filter.

FIG. 4 is a flowchart illustrating one example of a method for determining the filter characteristics of the first FIR filter and the second FIR filter.

FIG. 5 is a diagram illustrating advantageous effects obtained from the speaker device according to the embodiment.

FIG. 6 is a graph showing one example of a directivity of sound emitted from a speaker device according to a comparative example.

FIG. 7 is a graph showing one example of a directivity of sound emitted from the speaker device according to the embodiment.

FIG. 8 is a plan view showing one example of an external appearance of a speaker device according to Variation 1 of the embodiment.

FIG. 9 is a plan view showing one example of an external appearance of another speaker device according to Variation 1 of the embodiment.

FIG. 10 is a block diagram showing one example of a functional configuration of a speaker device according to Variation 2 of the embodiment.

FIG. 11 is a plan view showing one example of an external appearance of a speaker device according to Variation 3 of the embodiment.

FIG. 12 is a graph showing one example of a directivity of sound emitted from a speaker device configured by removing a sound absorber and a sound reflector from the speaker device according to Variation 3 of the embodiment.

FIG. 13 is a graph showing one example of a directivity of sound emitted from the speaker device according to Variation 3 of the embodiment.

FIG. 14 is a plan view showing one example of an external appearance of a first another speaker device according to Variation 3 of the embodiment.

FIG. 15 is a plan view showing one example of an external appearance of a second another speaker device according to Variation 3 of the embodiment.

FIG. 16 is a plan view showing one example of an external appearance of a third another speaker device according to Variation 3 of the embodiment.

### DESCRIPTION OF EMBODIMENTS

### Summary of Present Disclosure

Hereinafter, an example of a speaker device according to the present disclosure will be described as the summary of the present disclosure.

A speaker device according to a first aspect of the present disclosure includes: a signal processing circuit that performs signal processing on a first sound signal that is input, and generates a first output signal and a second output signal; a first loudspeaker that outputs a first sound that is based on the first output signal in a first direction; a first horn that emits, in the first direction, the first sound output from the first loudspeaker; and a second loudspeaker that is provided at a position in a second direction relative to the first loudspeaker, and outputs a second sound that is based on the second output signal, the second direction being a direction opposite to the first direction, wherein the signal processing circuit includes a first filter and a second filter that perform the signal processing on, out of the first sound signal, a signal in at least a portion of frequency bands, the first output signal is generated based on an output of the first filter, the second output signal is generated based on an output of the second filter, the first filter and the second filter have filter characteristics for adjusting a phase and an amplitude per frequency of the signal in at least the portion of the frequency bands out of the first sound signal to cause a sound pressure of a sound based on the first sound signal at a second position to be lower than a sound pressure of the sound based on the first sound signal at a first position by a predetermined value or more as a result of the first sound and the second sound overlapping each other, the first position is located in front of the first loudspeaker in the first direction, and the second position is located in a direction at a predetermined angle relative to the first speaker, the predetermined angle being an angle formed with respect to the first direction.

With this configuration, it is possible to achieve a speaker device that has directivity for sounds in a wide frequency range. Specifically, the straight traveling properties of the first sound are enhanced by the first horn, and thus the directivity of sound emitted from the speaker device can be enhanced. The improvement in directivity is particularly effective for a high-range sound with a high level of straight traveling properties. Also, the first sound and the second sound are sounds that are based on the outputs of the first filter and the second filter, and the sound pressure of the sound that is based on the first sound signal at the second position is made lower than the sound pressure of the sound that is based on the first sound signal at the first position by a predetermined value or more as a result of the first sound being cancelled out by the second sound. For this reason, the directivity of sounds in the mid-low sound range in which an interference between the first sound and the second sound is likely to occur can be enhanced. Also, for the first sound signal, the phase and the amplitude per frequency is adjusted by the first filter and the second filter, and thus, as compared with the case where a sound with a phase opposite to that of the first sound is simply used as the second sound, the first sound is cancelled out by the second sound in a wide frequency range, which also increases the amount of sound cancelled out. Accordingly, it is possible to achieve a speaker device that has directivity for sounds in a wide frequency range.

Also, for example, a speaker device according to a second aspect of the present disclosure is the speaker device according to the first aspect, wherein the signal processing circuit includes a low-pass filter into which the first sound signal is input, and the first filter and the second filter perform the signal processing on an output of the low-pass filter.

With this configuration, the amount of processing performed by the first filter and the second filter can be reduced.

Also, for example, a speaker device according to a third aspect of the present disclosure is the speaker device according to the first or second aspect, further including: a housing that is cylindrical in shape and whose axial direction coincides with the first direction, wherein the first loudspeaker is provided at an end portion of the housing in the first direction, and a plurality of through holes are provided in a circumferential side wall of the housing.

With this configuration, a sound with a phase opposite to that of the first sound is output from the plurality of through holes, and the first sound is cancelled out by the sound with a phase opposite to that of the first sound. Accordingly, the directivity of sound emitted from the speaker device can be further enhanced.

Also, for example, a speaker device according to a fourth aspect of the present disclosure is the speaker device according to any one of the first to third aspects, wherein the second loudspeaker outputs the second sound in the second direction.

With this configuration, it is possible to extend the distance between the output position of the first sound from the first loudspeaker and the output position of the second sound from the second loudspeaker while preventing the size of the entire speaker device from increasing, and reduce the sound pressure of the sound that is based on the first sound signal at the second position.

Also, for example, a speaker device according to a fifth aspect of the present disclosure is the speaker device according to any one of the first to fourth aspects, further including: a diffuser that diffuses the second sound output from the second loudspeaker.

With this configuration, the second sound is diffused, and thus the cancellation range in which the first sound is cancelled out by the second sound can be expanded.

Also, for example, a speaker device according to a sixth aspect of the present disclosure is the speaker device according to any one of the first to fifth aspects, further including: a second horn that emits, in the first direction, the second sound output from the second loudspeaker.

With this configuration, the second horn can prevent the path difference between the first sound and the second sound that travel in the second direction of the speaker device from increasing, and thus the first sound is likely to be cancelled out by the second sound in the second direction of the speaker device as well.

Also, for example, a speaker device according to a seventh aspect of the present disclosure is the speaker device according to any one of the first to sixth aspects, wherein the signal processing circuit includes an adder that generates the second output signal by adding a second sound signal that indicates a masking sound to the output of the second filter.

With this configuration, the second sound includes a masking sound. For this reason, even in the case where the speaker device is installed in a quiet environment, with the masking sound, it is possible to make the sound that is based on the first sound signal difficult to be heard at the second position.

Also, for example, a speaker device according to an eighth aspect of the present disclosure is the speaker device according to the first to seventh aspects, further including: a sound absorber that is in a shape of a plate and provided to include a portion that surrounds the first loudspeaker and the second loudspeaker as viewed from the first direction, wherein the sound absorber absorbs the first sound and the second sound that travel in the second direction, and the predetermined angle is an angle between a first angle and a second angle, the first angle being an angle formed by the first direction and an extension direction of a surface of the sound absorber in the first direction as viewed in a cross section taken along a plane parallel to the first direction that passes through a center of the first loudspeaker, the second angle being an angle formed by the first direction and a direction that connects a sound output position of the first loudspeaker and an end portion of the surface of the sound absorber as viewed in the cross section.

As a result of the sound absorber absorbing sound, the sound pressure can be reduced on the second direction side of the speaker device where first sound is unlikely to be cancelled out by the second sound, and thus the directivity can be enhanced.

Also, for example, a speaker device according to a ninth aspect of the present disclosure is the speaker device according to the eighth aspect, further including: a sound reflector that is in a shape of a plate and provided at a position in the second direction relative to the sound absorber.

With this configuration, out of the first sound and the second sound that have entered the sound absorber, a component that was not absorbed by the sound absorber is reflected. Accordingly, the sound pressure can be further reduced on the second direction side of the speaker device, and thus the directivity can be enhanced.

Also, for example, a speaker device according to a tenth aspect of the present disclosure is the speaker device according to the eighth or ninth aspect, wherein the first angle is 90 degrees.

With this configuration, when a portion of the sound emitted from the speaker device is reflected by the sound absorber, it is possible to suppress disturbance of the sound pressure characteristics of the sound emitted from the speaker device.

Hereinafter, an exemplary embodiment will be described in detail with reference to the accompanying drawings. However, an unnecessarily detailed description may be omitted. For example, a detailed description of a well-known matter and a redundant description of a substantially identical configuration may be omitted. This is done to avoid unnecessary redundancy in the following description and to facilitate those skilled in the art to understand the present disclosure.

It should be noted that the accompanying drawings and the following description are provided by the inventors of the present application to facilitate sufficient understanding of the present disclosure by those skilled in the art, and are thus not intended to limit the scope of the subject matter recited in the claims.

In the embodiment given below, for the sake of convenience of the description, the front-back direction is aligned with the X-axis direction, the right-left direction (lateral direction) is aligned with the Y-axis direction, and the up-down direction is aligned with the Z-axis direction. However, they are not intended to limit the orientation of the speaker device according to the present disclosure when it is produced or used. Also, the X axis, the Y axis, and the Z axis represent three axes in a three-dimensional orthogonal coordinate system. In the following description, for example, the term “X-axis plus direction” refers to a direction indicated by the arrow extending in the X axis, the term “X-axis minus direction” refers to a direction opposite to the X-axis plus direction. The same applies to the Y-axis direction and the Z-axis direction. Also, the X-axis plus direction (front direction) is one example of a first direction, and the X-axis minus direction (rear direction) is one example of a second direction. In addition, the diagrams are schematic representations, and thus are not necessarily true to scale. Also, in the diagrams, dimensions and the like are not necessarily the same in the diagrams.

Also, in the specification of the present application, unless otherwise stated, ordinal numbers such as “first” and “second” do not mean the number or order of structural elements, and are used to avoid confusion of the same type of structural elements and make a distinction between the same type of structural elements.

### Embodiment

Hereinafter, a speaker device according to the present embodiment will be described.

### [Configuration]

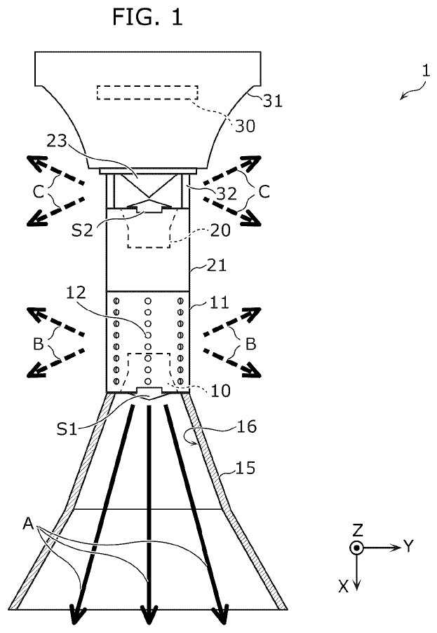

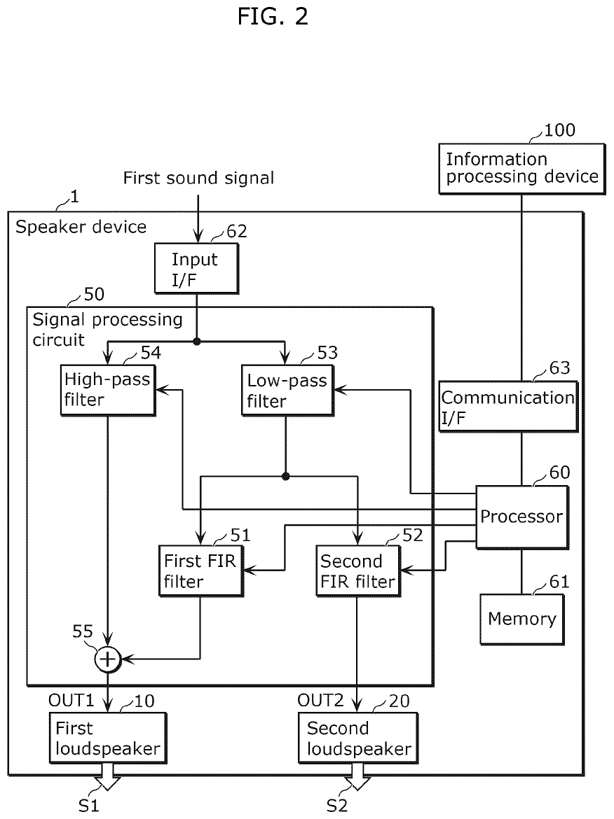

First, a configuration of the speaker device according to the present embodiment will be described with reference to FIGS. 1 and 2.

FIG. 1 is a plan view showing one example of an external appearance of speaker device 1 according to the present embodiment. FIG. 2 is a block diagram showing one example of a functional configuration of speaker device 1 according to the present embodiment. FIG. 1 shows the external appearance of speaker device 1 as viewed from above (from the Z-axis plus direction). In FIG. 1, for the sake of the description, first horn 15 is shown in a cross section taken in half along the XY plane. However, there is actually the other half of first horn 15 on the front side (the Z-axis plus direction side) of FIG. 1. Also, in FIG. 1, first loudspeaker 10, second loudspeaker 20, and substrate 30 that are housed respectively in first housing 11, second housing 21, and third housing 31 are indicated by broken lines. Also, in FIG. 1, the sound output from first loudspeaker 10 through first horn 15 are schematically indicated by solid arrows A, the sounds output from a plurality of through holes 12 are schematically indicated by broken arrows B, and the sounds output from second loudspeaker 20 are schematically indicated by broken arrows C.

As shown in FIG. 1, speaker device 1 includes first loudspeaker 10, first housing 11 that houses first loudspeaker 10, first horn 15, second loudspeaker 20, second housing 21 that houses second loudspeaker 20, diffuser 23, substrate 30 and third housing 31 that houses substrate 30. In the example shown in FIG. 1, third housing 31, second housing 21, and first housing 11 are arranged in this order along the X-axis plus direction.

Speaker device 1 is, for example, a small-sized directional loudspeaker with a length in the front-back direction of about 40 cm and a length in the right-left direction of about 20 cm. Speaker device 1 includes two loudspeakers, specifically, first loudspeaker 10 and second loudspeaker 20. Accordingly, speaker device 1 can be easily small-sized, and achieve high quality sound while having directivity. Speaker device 1 may be installed in, for example, a home, an office, or a shared space such as a commercial facility.

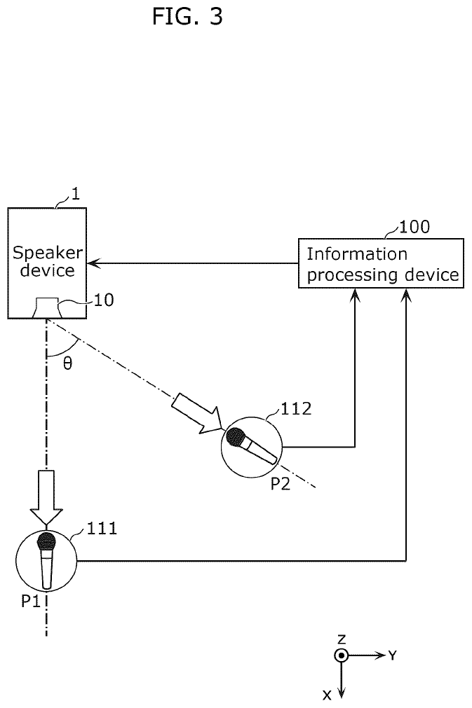

Speaker device 1 that is a directional loudspeaker allows people in a predetermined area that is on the X-axis plus direction side of speaker device 1 to hear sounds emitted from speaker device 1, and at the same time, makes it difficult for people outside the predetermined area to hear the sounds emitted from speaker device 1. In particular, it is important for a directional loudspeaker to reduce the sound pressure of sounds in a wide frequency range at a location (for example, second position P2 shown in FIG. 3, which will be described later) where it is necessary to make it difficult for people to hear the sounds emitted from the loudspeaker. Speaker device 1 can reduce the sound pressure of sounds in a wide frequency range at a desired location.

First loudspeaker 10 is provided at an end portion of first housing 11 that is on the X-axis plus direction side, and outputs first sound S1 in the X-axis plus direction. First sound S1 corresponds to a sound indicated by a first sound signal, which will be described later. First loudspeaker 10 includes, for example, a diaphragm, a magnetic circuit, a voice coil, and the like. First loudspeaker 10 is fixed to first housing 11 at the end portion of first housing 11 that is on the X-axis plus direction side so as to expose the diaphragm of first loudspeaker 10. As a result of the diaphragm of first loudspeaker 10 vibrating in the front-back direction, first sound S1 is output in the X-axis plus direction.

First housing 11 is a housing that is cylindrical in shape and whose axial direction is the X-axis plus direction. First housing 11 includes an inner space for housing first loudspeaker 10, and is also called a loudspeaker cabinet or a loudspeaker box. First housing 11 has, for example, a cylindrical outer shape. An opening for installing first loudspeaker 10 is formed at the end portion of first housing 11 that is on the X-axis plus direction side, and the opening is closed by first loudspeaker 10. Also, an end portion of first housing 11 that is on the X-axis minus direction side is closed by a plate-shaped member. As viewed from the X-axis plus direction, the center of first loudspeaker 10 and the center of first housing coincide with each other.

The plurality of through holes 12 that connect the inner space of first housing 11 to an outside of first housing 11 are formed in a circumferential side wall of first housing 11. A sound with a phase opposite to that of first sound S1 output from first loudspeaker 10 in the inner space of first housing 11 is output from the plurality of through holes 12. The position at which through hole 12 is provided is not limited to that of the example shown in FIG. 1.

First horn 15 emits first sound S1 output from first loudspeaker 10 in the X-axis plus direction. As used herein, the expression “to emit sound in the X-axis plus direction means that the sound is emitted in a range around the X-axis plus direction. First horn 15 is provided on the X-axis plus direction side relative to first loudspeaker 10. As viewed from the X-axis plus direction, the center of first loudspeaker 10 and the center of first horn 15 coincide with each other. First horn 15 has a cylindrical shape, and is attached to the end portion of first housing 11 that is on the X-axis plus direction side so as to have openings in the X-axis plus direction and the X-axis minus direction (or in other words, in the front-back direction) and surround a space in first loudspeaker 10 that is on the X-axis plus direction side. The opening of first horn 15 that is on the X-axis minus direction side is closed by first loudspeaker 10 and first housing 11, and the opening of first horn 15 that is on the X-axis plus direction side is open. The axial direction of first horn 15 coincides with the X-axis plus direction.

First horn 15 includes inner surface 16 that becomes gradually wider toward the X-axis plus direction. In the example shown in FIG. 1, the angle formed by the normal line of inner surface 16 and the X-axis plus direction is changed in two stages so as to be smaller on the X-axis plus direction side. The angle formed by the normal line of inner surface 16 and the X-axis plus direction may be changed in three or more stages or continuously, or may remain constant without a change. The angle formed by the normal line of inner surface 16 and the X-axis plus direction (the average angle in the case where the angle is changed) is greater than, for example, predetermined angle θ, which will be described later.

Second loudspeaker 20 is provided on the X-axis minus direction side relative to first loudspeaker 10, and outputs second sound S2 in the X-axis minus direction. Second loudspeaker 20 is provided at an end portion of second housing 21 that is on the X-axis minus direction side. As viewed from the X-axis plus direction, the center of first loudspeaker 10 and the center of second loudspeaker 20 coincide with each other. Second sound S2 includes a cancellation sound whose phase is different from that of first sound S1, and thus can cancel out first sound S1. For this reason, as a result of first sound S1 and second sound S2 overlapping at a certain position, the sound pressure of synthesized sound of first sound S1 and second sound S2 at that position is reduced. Second loudspeaker 20 includes, for example, a diaphragm, a magnetic circuit, a voice coil, and the like. Second loudspeaker 20 is fixed to second housing 21 at an end portion of second housing 21 that is on the X-axis minus direction side so as to expose the diaphragm of second loudspeaker 20. As a result of the diaphragm of second loudspeaker 20 vibrating in the front-back direction, second sound S2 is output in the X-axis minus direction.

Second housing 21 is a housing that is cylindrical in shape and whose axial direction is the X-axis plus direction. Second housing 21 is connected to the end portion of first housing 11 that is on the X-axis minus direction side. First housing 11 and second housing 21 may be connected via a connecting member. Second housing 21 includes an inner space for housing second loudspeaker 20, and is also called a loudspeaker cabinet or a loudspeaker box. Second housing 21 has, for example, cylindrical outer shape. An opening for installing second loudspeaker 20 is formed at the end portion of second housing 21 that is on the X-axis minus direction side, and the opening is closed by second loudspeaker 20. Also, an end portion of second housing 21 that is on the X-axis plus direction side is closed by a plate-shaped member. As viewed from the X-axis plus direction, the center of second loudspeaker 20 and the center of second housing 21 coincide with each other. Also, no through hole is formed on a side wall of second housing 21.

Diffuser 23 is a member that diffuses second sound S2 output from second loudspeaker 20. Second sound S2 is diffused by diffuser 23, and it is therefore possible to extend the cancellation range of first sound S1 by second sound S2. Also, it is possible to prevent the sound pressure of second sound S2 from increasing at a specific location.

Diffuser 23 is provided on an output direction side of second sound S2 relative to second loudspeaker 20, or in other words, diffuser 23 is provided to face second loudspeaker 20 on the X-axis minus direction side relative to second loudspeaker 20. Also, diffuser 23 is fixed to an end portion of third housing 31 that is on the X-axis plus direction side. In the example shown in FIG. 1, diffuser 23 includes a conical portion that protrudes toward second loudspeaker 20. There is no particular limitation on the shape of diffuser 23 as long as second sound S2 can be diffused.

Substrate 30 is a substrate on which signal processing circuit 50 and the like, which will be described later, are formed. Substrate 30 is provided within third housing 31.

Third housing 31 is a housing that houses substrate 30. Third housing 31 is provided, on the X-axis minus direction side of second housing 21, to be spaced apart from second housing 21, and is connected to second housing 21 via connecting member 32. In the example shown in FIG. 1, third housing 31 has a frustoconical shape, but may have a cylindrical shape or a prismatic shape. Although not shown in the diagrams, an attachment member for attaching speaker device 1 to the ceiling or the like may be provided at an end portion of third housing 31 that is on the X-axis minus direction side. There is no particular limitation on the orientation in which speaker device 1 is attached. However, for example, speaker device 1 is attached directly or via a rail to the ceiling to hang from the ceiling such that the X-axis plus direction coincides with the vertically downward direction. Also, speaker device 1 may be supported by a stand or the like such that the X-axis plus direction coincides with the horizontal direction.

As shown in FIG. 2, speaker device 1 further includes signal processing circuit 50, processor 60, memory 61, input interface (I/F) 62, and communication interface (I/F) 63. Signal processing circuit 50, processor 60, memory 61, input interface 62, and communication interface 63 are mounted on, for example, substrate 30 shown in FIG. 1. However, a portion of these may be mounted on a substrate different from substrate 30.

Signal processing circuit 50 performs signal processing on a first sound signal that is input into signal processing circuit 50 via input interface 62, and generates first output signal OUT1 and second output signal OUT2. The first sound signal is a sound signal that is input from an external sound signal output device such as an audio player. First loudspeaker 10 outputs first sound S1 based on first output signal OUT1 generated by signal processing circuit 50. Also, second loudspeaker 20 outputs second sound S2 based on second output signal OUT2 generated by signal processing circuit 50. Signal processing circuit 50 may receive an input of the first sound signal that is based on audio data stored in memory 61.

Signal processing circuit 50 includes first finite impulse response (FIR) filter 51, second FIR filter 52, low-pass filter 53, high-pass filter 54, and adder 55. First FIR filter 51 is one example of a first filter, and second FIR filter 52 is one example of a second filter.

First FIR filter 51 and second FIR filter 52 perform signal processing on an output of low-pass filter 53 that is a signal in a portion of frequency bands of the first sound signal. First FIR filter 51 and second FIR filter 52 are adaptive filters in which filter characteristics determined based on the adaptive filter design are set. First FIR filter 51 and second FIR filter 52 adjust phase and amplitude per frequency of the input signal. Specifically, first FIR filter 51 and second FIR filter 52 applies (multiplication) control coefficients of the phase and the amplitude per frequency to the input signal, and outputs the result. The filter characteristics of first FIR filter 51 and second FIR filter 52 are determined by, for example, information processing device 100. The filter characteristics of first FIR filter 51 and second FIR filter 52 will be described later in detail.

Low-pass filter 53 receives an input of the first sound signal via input interface 62. Low-pass filter 53 is set to a predetermined cutoff frequency, and allows, out of the first sound signal, a signal in a frequency band lower than the cutoff frequency to pass therethrough. The cutoff frequency of low-pass filter 53 is, for example, 1 kHz or more and 5 kHz or less. The cutoff frequency of low-pass filter 53 may be 2 kHz or more and 4 kHz or less. As a result of the first sound signal being input into low-pass filter 53, the amount of subsequent processing can be reduced. Also, with a high-range sound, it is difficult to cancel out first sound S1 by overlapping first sound S1 and second sound S2, and even when it is blocked by low-pass filter 53, there is little influence of the directivity of speaker device 1.

High-pass filter 54 receives an input of the first sound signal via input interface 62. High-pass filter 54 is set to a predetermined cutoff frequency, and allows, out of the first sound signal, a signal in a frequency higher than the cutoff frequency to pass therethrough. The cutoff frequency of high-pass filter 54 is set to be, for example, the same cutoff frequency as that of low-pass filter 53.

Adder 55 adds the output of first FIR filter 51 and the output of high-pass filter 54, and outputs a signal obtained from the addition.

In signal processing circuit 50, first output signal OUT1 is generated based on the output of first FIR filter 51. In the example shown in FIG. 2, first output signal OUT1 is generated as a result of adder 55 adding the output of first FIR filter 51 and the output of high-pass filter 54. That is, first output signal OUT1 is an output of adder 55. Also, second output signal OUT2 is generated based on an output of second FIR filter 52. In the example shown in FIG. 2, second output signal OUT2 is the output of second FIR filter 52.

Processor 60 is a processing circuit that performs various types of information processing for speaker device 1 to emit sound. Processor 60 implements various functions by executing a program stored in memory 61.

Processor 60 stores, for example, information received from external information processing device 100 or the like via communication interface 63 in memory 61. The information received by processor 60 includes, for example, filter characteristics, and the like of first FIR filter 51, second FIR filter 52, low-pass filter 53, and high-pass filter 54. Also, processor 60 may update the filter characteristics of first FIR filter 51, second FIR filter 52, low-pass filter 53, and high-pass filter 54 stored in memory 61 based on the information received from external information processing device 100 or the like. For example, when the power of speaker device 1 is turned on, processor 60 reads out the filter characteristics of first FIR filter 51, second FIR filter 52, low-pass filter 53, and high-pass filter 54 from memory 61, and sets the read-out filter characteristics in each of the filters.

Memory 61 is a storage device that stores data required for the program executed by processor 60 and the processing executed by processor 60. For example, the filter characteristics of first FIR filter 51, second FIR filter 52, low-pass filter 53, and high-pass filter 54 are stored in memory 61. Memory 61 is composed of, for example, a semiconductor memory such as, for example, a flash memory. The storage device may include a hard disk drive (HDD) and the like.

Input interface 62 receives an external first sound signal, and inputs the received first sound signal into signal processing circuit 50. Input interface 62 is, for example, an analog audio input interface or an optical digital input interface, but may be a Bluetooth (registered trademark) interface, a universal serial bus (USB) interface, or a Wi-Fi (registered trademark) interface. In the case where the first sound signal is an analog signal, AD conversion is performed by signal processing circuit 50 or input interface 62.

Communication interface 63 is a communication circuit for performing communication with an external device such as information processing device 100. Speaker device 1 is connected to the external device such as information processing device 100 via communication interface 63. The communication via communication interface 63 may be wireless communication or wired communication. There is no particular limitation on the communication standard of the communication performed by communication interface 63. Speaker device 1 does not need to be connected all the time to an external device such as information processing device 100, and may be connected to the external device only when communication is required such as when determining the filter characteristics of first FIR filter 51 and second FIR filter 52, which will be described later.

Information processing device 100 is a computer for determining the filter characteristics of first FIR filter 51 and second FIR filter 52. Information processing device 100 includes, for example, a processor, a memory, a communication interface, a user interface, and the like. Information processing device 100 determines the filter characteristics of first FIR filter 51 and second FIR filter 52 as a result of the program stored in the memory being executed by the processor. The filter characteristics of first FIR filter 51 and second FIR filter 52 determined by information processing device 100 are transmitted to speaker device 1.

### [Filter Characteristics of First FIR Filter and Second FIR Filter]

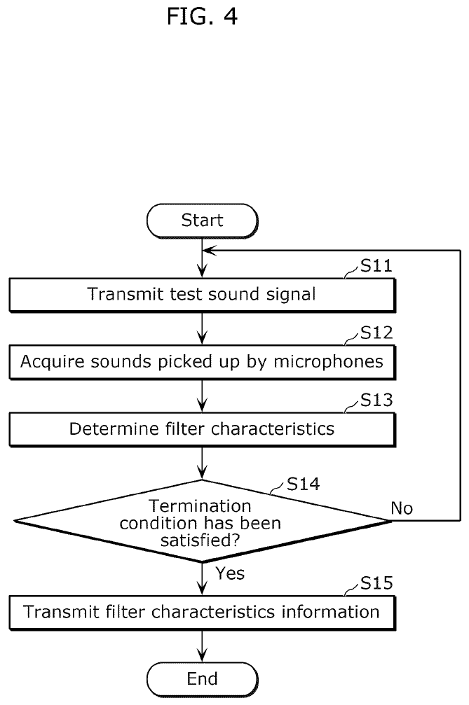

Here, the filter characteristics of first FIR filter 51 and second FIR filter 52 will be described with reference to FIGS. 3 and 4.

FIG. 3 is a diagram illustrating a method for designing the filter characteristics of first FIR filter 51 and second FIR filter 52. FIG. 4 is a flowchart illustrating one example of a method for determining the filter characteristics of first FIR filter 51 and second FIR filter 52.

First, the filter characteristics of first FIR filter 51 and second FIR filter 52 will be described in detail with reference to FIG. 3.

When first loudspeaker 10 emits first sound S1, and second loudspeaker 20 emits second sound S2, first sound S1 and second sound S2 overlap at each of first position P1 and second position P2, and a synthesized sound of first sound S1 and second sound S2 is heard as the sound from speaker device 1. First FIR filter 51 and second FIR filter 52 are adaptive filters set to cause the sound from speaker device 1 to have desired audio characteristics at first position P1 and second position P2. First FIR filter 51 and second FIR filter 52 have filter characteristics for adjusting the phase and the amplitude per frequency of the input signal so as to cause the sound pressure of the sound based on the first sound signal at second position P2 to be lower than the sound pressure of the sound based on the first sound signal at first position P1 by a predetermined value or more, by first sound S1 and second sound S2 overlapping each other. The filter characteristics include phase characteristics per frequency and amplitude characteristics per frequency, and specifically, control coefficients of the phase and the amplitude per frequency. Such filter characteristics can be implemented by adaptive filter design, which will be described later.

As shown in FIG. 3, first position P1 is located in front of first loudspeaker 10 in the X-axis plus direction. Second position P2 is located in a direction at predetermined angle θ relative to first loudspeaker 10 in the X-axis plus direction, predetermined angle θ being an angle formed with respect to the X-axis plus direction. The reference position based on which predetermined angle θ is determined is set to, for example, a sound output position of first loudspeaker 10, but may be offset from the sound output position of first loudspeaker 10 in the X-axis direction. For example, the reference position based on which predetermined angle θ is determined may be set to a position between the sound output position of first loudspeaker 10 and a sound output position of second loudspeaker 20. Also, for example, the reference position based on which predetermined angle θ is determined may be set to a position between the center of a front end portion of first horn 15 and the sound output position of second loudspeaker 20. The center of the front end portion of first horn 15 is, specifically, an intersection of a straight line that passes through the center of first loudspeaker 10 and is parallel to the X-axis plus direction and a plane that includes the front end portion of first horn 15 and is perpendicular to the X-axis plus direction. As one example, predetermined angle θ is set to 60 degrees, but may be set according to the directivity angle range of speaker device 1. Predetermined angle θ is set to, for example, 30 degrees or more and 180 degrees or less. Predetermined angle θ may be set to 45 degrees or more and 120 degrees or less. First position P1 and second position P2 are located on, for example, a concentric circle around the sound output position of first loudspeaker 10. The concentric circle has a radius of, for example, 0.5 m or more and 2 m or less.

The filter characteristics of first FIR filter 51 and second FIR filter 52 are set such that the synthesized sound of first sound S1 and second sound S2 based on the first sound signal has desired amplitude frequency characteristics at each of first position P1 and second position P2. Specifically, the filter characteristics of first FIR filter 51 and second FIR filter 52 are designed to set target amplitude frequency characteristics at second position P2 to be lower than target amplitude frequency characteristics at first position P1 by an amount corresponding to a predetermined sound pressure. With this configuration, at second position P2, second sound S2 is closer to a phase opposite to that of first sound S1, and thus the sound pressure at second position P2 is lower than the sound pressure at first position P1. Also, first FIR filter 51 has, for example, filter characteristics for increasing the amplitude of the input signal in a predetermined frequency range of a frequency of 1 kHz or less. With this configuration, it is possible to compensate for the sound pressure in a low sound range of the synthesized sound whose sound pressure may be reduced as a result of first sound S1 and second sound S2 overlapping at first position P1.

Next, a method for determining the filter characteristics of first FIR filter 51 and second FIR filter 52 performed by information processing device 100 will be described with reference to FIGS. 3 and 4. FIG. 4 shows processing for adaptive filter design performed by information processing device 100.

Information processing device 100 determines the filter characteristics of first FIR filter 51 and second FIR filter 52 using, for example, microphone 111 provided at first position P1 and microphone 112 provided at second position P2. Information processing device 100 first transmits a test sound signal to speaker device 1 (step S11). Speaker device 1 receives the transmitted test sound signal using input interface 62. The received test sound signal is subjected to signal processing by signal processing circuit 50 and output to first loudspeaker 10 and second loudspeaker 20, and then, a test sound that is based on the test sound signal is output from first loudspeaker 10 and second loudspeaker 20. At this time, the initial value of the filter characteristics of first FIR filter 51 and second FIR filter 52 is set, for example, to an arbitrary value by the user.

Next, the test sound emitted from speaker device 1 is picked up by microphone 111 and microphone 112, and information processing device 100 acquires test sounds picked up by microphone 111 and microphone 112 at first position P1 and second position P2 at which microphone 111 and microphone 112 picked up the test sound emitted from speaker device 1 (step S12). Then, information processing device 100 determines, based on the test sounds acquired in step S12, the filter characteristics of first FIR filter 51 and second FIR filter 52 (step S13). Specifically, in information processing device 100, target amplitude frequency characteristics of the test sounds picked up at first position P1 and second position P2 have been set by the user. Information processing device 100 determines the filter characteristics of first FIR filter 51 and second FIR filter 52 such that the amplitude frequency characteristics of the test sounds picked up at first position P1 and second position P2 asymptotically approach the target amplitude frequency characteristics at each of first position P1 and second position P2. At this time, the filter characteristics may be determined using a known algorithm such as, for example, a least mean square (LMS) algorithm (least squares method).

For example, as the target amplitude frequency characteristics of the test sound at first position P1, characteristics that are the same as the amplitude frequency characteristics of the test sound signal transmitted from information processing device 100 are set. Also, for example, as the target amplitude frequency characteristics of the test sound at second position P2, amplitude frequency characteristics that are reduced from the target amplitude frequency characteristics of the test sound at first position P1 by an amount corresponding to a predetermined sound pressure are set. The average value of the predetermined sound pressure in the frequency range in which the adaptive filter design is performed is, for example, 10 dB or more and 30 dB or less. The target amplitude frequency characteristics of the test sounds picked up at first position P1 and second position P2 described above are merely one example, and can be set to amplitude frequency characteristics that are ideal at first position P1 and second position P2 according to the audio design or the like.

Next, information processing device 100 determines whether a termination condition for terminating the adaptive filter design has been satisfied (step S14). The termination condition is a condition that, for example, whether a difference between the amplitude frequency characteristics of the test sounds picked up at first position P1 and second position P2 and the target amplitude frequency characteristics of the test sounds picked up at first position P1 and second position P2 is less than or equal to a threshold value.

If it is determined that the difference is greater than the threshold value, information processing device 100 determines that the termination condition has not been satisfied (No in step S14), and again performs the processing starting from step S11 using the filter characteristics of first FIR filter 51 and second FIR filter 52 determined above. The filter characteristics of first FIR filter 51 and second FIR filter 52 are designed so as to be closer to the target amplitude frequency characteristics of the test sounds picked up at first position P1 and second position P2 as a result of the processing from step S11 to step S13 being repeated.

On the other hand, if it is determined that the difference is less than or equal to the threshold value, information processing device 100 determines that the termination condition has been satisfied (Yes in step S14), and transmits, to speaker device 1, filter characteristics information that indicates the filter characteristics of first FIR filter 51 and second FIR filter 52 determined in step S13 (step S15). Speaker device 1 receives the transmitted filter characteristics information using communication interface 63, and processor 60 updates the filter characteristics of first FIR filter 51 and second FIR filter 52 stored in memory 61 by the filter characteristics indicated by the received filter characteristics information. Also, processor 60 sets the updated filter characteristics in first FIR filter 51 and second FIR filter 52.

In step S14, information processing device 100 may also determine that the termination condition has been satisfied when a predetermined length of time elapses (when a predetermined number of times is reached).

With the adaptive filter design performed by information processing device 100 described above, the filter characteristics of first FIR filter 51 and second FIR filter 52 are determined so as to cause the difference of the sound pressure of the test sound at second position P2 relative to the sound pressure of the test sound at first position P1 to be lower by an amount corresponding to a predetermined sound pressure. Processor 60 operates signal processing circuit 50 based on the determined filter characteristics. As a result, the filter characteristics of first FIR filter 51 and second FIR filter 52 are set such that the sound pressure of the sound based on the first sound signal at second position P2 is lower than the sound pressure of the sound based on the first sound signal at first position P1 by a predetermined value or more.

The adaptive filter design performed by information processing device 100 is performed, for example, as the initial setting at the production of speaker device 1, but may be performed after speaker device 1 has been installed.

### Advantageous Effects, Etc.

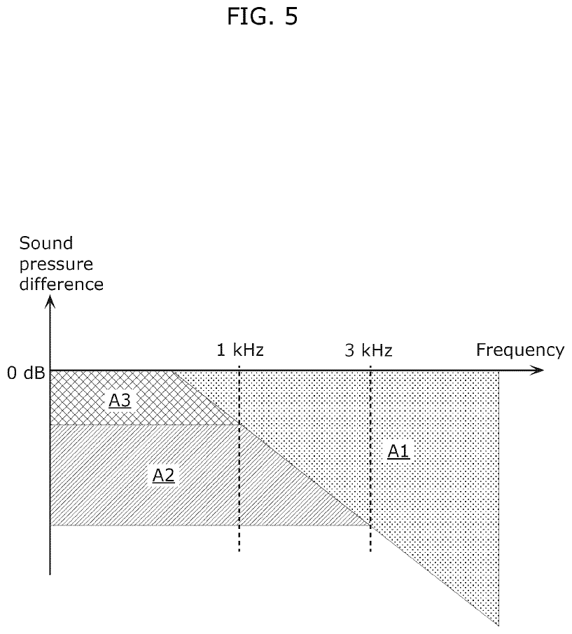

Next, advantageous effects of speaker device 1 will be described. With speaker device 1, due to the configuration described above, the directivity for sounds in a wide frequency range can be obtained. This will be described with reference to FIG. 5. FIG. 5 is a diagram illustrating advantageous effects obtained from speaker device 1. In FIG. 5, the vertical axis indicates the difference of the sound pressure of the sound that is based on the first sound signal at second position P2 relative to the sound pressure of the sound that is based on the first sound signal at first position P1. That is, it shows that the directivity increases toward the negative side of the vertical axis shown in FIG. 5 because the sound pressure of the sound based on the first sound signal at second position P2 decreases to be lower than the sound pressure of the sound based on the first sound signal at first position P1. Also, in FIG. 5, the horizontal axis indicates frequency. Also, in FIG. 5, region A1 schematically indicates the contribution of first horn 15 to directivity. Also, in FIG. 5, region A2 schematically indicates the contribution of cancellation of first sound S1 by second sound S2 from second loudspeaker 20 to directivity. Also, in FIG. 5, region A3 schematically indicates the contribution of the plurality of through holes 12 to directivity. The contributions to directivity shown in regions A1 to A3 are merely one schematic example, and thus the size of region, the frequency range, and the like are not limited to those shown in FIG. 5.

The straight traveling properties of first sound S1 output from first loudspeaker 10 in the X-axis plus direction is enhanced by first horn 15. In first horn 15, mainly, the directivity in a high sound range of 3 kHz or more that has a high straight traveling properties is enhanced. On the other hand, the straight traveling properties is reduced more as the sound frequence is lower. For this reason, as can be seen from region A1, the contribution of first horn 15 to directivity is also reduced. By increasing the size of first horn 15, it is also possible to enhance the straight traveling properties of sound in a relatively low frequency, but it is disadvantageous for achieving the size reduction of speaker device 1.

Also, first sound S1 and second sound S2 are sounds that are based on outputs of first FIR filter 51 and second FIR filter 52, respectively. As described above, first FIR filter 51 and second FIR filter 52 have filter characteristics for adjusting the phase and the amplitude per frequency of first sound signal so as to cause the sound pressure of the sound based on the first sound signal at second position P2 to be lower than the sound pressure of the sound based on the first sound signal at first position P1 by a predetermined value or more. That is, the phase and the amplitude of second sound S2 output from second loudspeaker 20 are adjusted to cancel out first sound S1 as a result of second sound S2 overlapping first sound S1 at second position P2. In the cancellation of the sound as a result of first sound S1 and second sound S2 overlapping each other, it is easy to achieve a phase difference that cancels out as the frequency is lower, and thus, mainly, the directivity of a low sound range of 1 kHz or less is enhanced. Furthermore, the phase and the amplitude per frequency of first sound S1 and second sound S2 are adjusted by first FIR filter 51 and second FIR filter 52, and thus first sound S1 is cancelled out by second sound S2 even at a frequency higher than 1 kHz. For this reason, in a frequency in which it is difficult to sufficiently enhance directivity by first horn 15, as a result of first sound S1 being cancelled out by second sound S2, the directivity can be enhanced. For this reason, with speaker device 1, the directivity can be enhanced by, for example, superimposing region A1 and region A2 in a frequency range of 1 kHz or more and 3 kHz or less.

As described above, with speaker device 1, as a result of the straight traveling properties of sound in a high sound range being enhanced by first horn 15, and first sound S1 being cancelled out by second sound S2, the directivity for sounds in a wide frequency range can be obtained. In addition, the directivity of sounds in the mid-low sound range can also be enhanced without the need to increase the size of first horn 15, and thus the size reduction of speaker device 1 can be achieved.

Also, first loudspeaker 10 outputs, due to the diaphragm vibrating, first sound S1 in the X-axis plus direction, and also outputs a sound with a phase opposite to that of first sound S1 to the inner space of first housing 11. Because the plurality of through holes 12 are formed in the side wall of first housing 11, the sound with a phase opposite to that of first sound S1 output to the inner space of first housing 11 is output from the plurality of through holes 12 to the outside of first housing 11. Out of first sound S1, a sound that is emitted from first horn 15 and travels around in the right-left direction and the up-down direction is cancelled out by the sound output from the plurality of through holes 12. For this reason, as indicated by region A3, the plurality of through holes 12 enhance the directivity in a low sound range of 1 kHz or less in which the sound is particularly likely to travel around. Accordingly, in a frequency in which there is little contribution of first horn 15 to directivity, by cancelling out first sound S1 by the sound output from the plurality of through holes 12, the directivity can be enhanced.

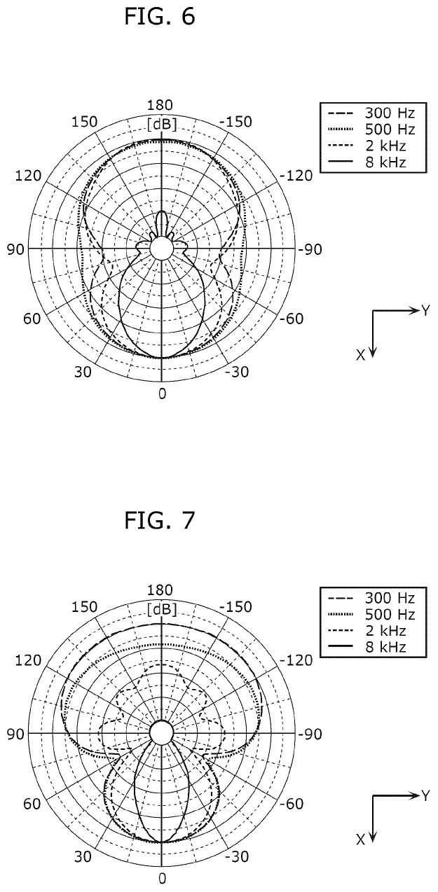

Next, measurement results of the directivity of sounds emitted from speaker device 1 will be described with reference to FIGS. 6 and 7. FIG. 6 is a graph showing one example of a directivity of sound emitted from a speaker device according to a comparative example. FIG. 7 is a graph showing one example of a directivity of sounds emitted from speaker device 1 according to the present embodiment. FIGS. 6 and 7 show sound pressure (unit: dB) based on the sound pressure at first position P1. Also, in FIGS. 6 and 7, the sound pressures of sounds at 300 Hz, 500 Hz, 2 kHz, and 8 kHz are shown. The speaker device according to the comparative example has the same configuration as that of speaker device 1, except that first horn 15 is not provided, and a plurality of through holes 12 are not formed in first housing 11. Also, in the speaker device according to the comparative example, second sound S2 based on second output signal OUT2 whose phase is opposite to that of first output signal OUT1 is output from second loudspeaker 20. Also, in speaker device 1 used to measure the sounds shown in FIG. 7, predetermined angle θ is 60 degrees.

As shown in FIG. 6, in the sounds emitted from the speaker device according to the comparative example, the direction in which the sound pressure decreases varies depending on the frequency. Also, in the sounds in some frequencies, the sound pressure is not sufficiently lowered in directions different from the X-axis plus direction. That is, with the speaker device according to the comparative example, it is not possible to enhance the directivity for sounds in a wide frequency range. Also, with speaker device according to the comparative example, for example, even when the time at which second sound S2 that is based on second output signal OUT2 is output is delayed as disclosed in PTL 1, the direction in which the sound pressure decreases cannot be aligned, and in the sounds in some frequencies, the sound pressure is not sufficiently lowered in directions different from the X-axis plus direction.

In contrast, as shown in FIG. 7, in the sounds emitted from speaker device 1 according to the present embodiment, the sound pressures of the sounds in all frequencies are lowered in directions that each form an angle of 60 degrees with respect to the X-axis plus direction. That is, with speaker device 1 according to the present embodiment, the directivity for sounds in a wide frequency range is enhanced. Also, in the sounds emitted from speaker device 1 according to the present embodiment, the range that is around the X-axis plus direction and where the sound pressure increases is smaller than that of the sounds emitted from the speaker device according to the comparative example, which means that the narrow directivity is achieved.

As described above, speaker device 1 can enhance the directivity for sounds in a wide frequency range due to the following features: speaker device 1 includes first horn 15; first sound S1 and second sound S2 that are respectively based on first FIR filter 51 and second FIR filter 52 are output from first loudspeaker 10 and second loudspeaker 20; and a plurality of through holes 12 are formed in first housing 11.

In addition, the effect of cancelling out first sound S1 by second sound S2 at second position P2 can be enhanced more as the distance between the output position of first sound S1 from first loudspeaker 10 and the output position of second sound S2 from second loudspeaker 20 is longer. In speaker device 1, second loudspeaker 20 outputs second sound S2 in the X-axis minus direction that is opposite to the X-axis plus direction in which first loudspeaker 10 outputs first sound S1, and thus the distance between the output position of first sound S1 from first loudspeaker 10 and the output position of second sound S2 from second loudspeaker 20 can be extended while suppressing an increase in the size of entire speaker device 1.

### [Variation 1]

Next, Variation 1 of the embodiment will be described. In the description of Variation 1 given below, differences from the embodiment will be mainly described, and a description of similarities will be omitted or simplified.

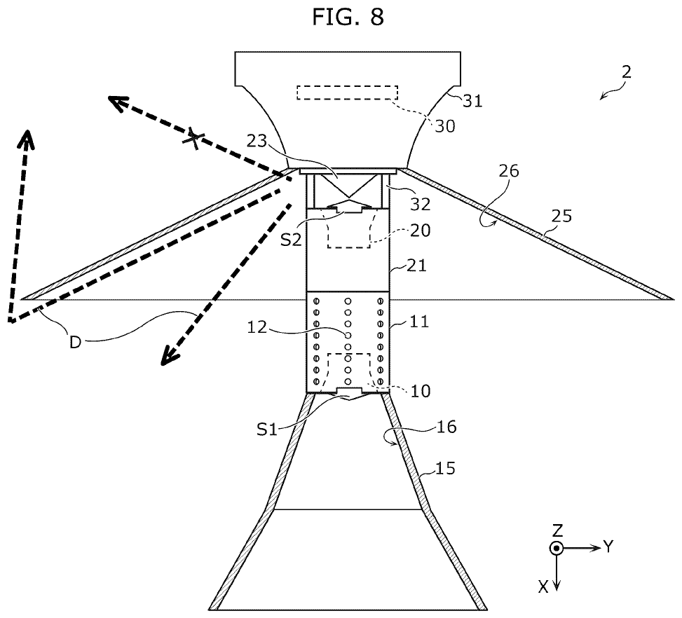

FIG. 8 is a plan view showing one example of an external appearance of speaker device 2 according to the present variation. FIG. 8 shows the external appearance of speaker device 2 as viewed from above (from the Z-axis plus direction). In FIG. 8, for the sake of the description, first horn 15 and second horn 25 are shown in a cross section taken in half along the XY plane. However, there is actually the other half of first horn 15 and second horn 25 on the front side (the Z-axis plus direction side) of FIG. 8. Also, in FIG. 8, first loudspeaker 10, second loudspeaker 20, and substrate 30 that are housed respectively in first housing 11, second housing 21, and third housing 31 are indicated by broken lines. Also, in FIG. 8, the sounds output from second loudspeaker 20 are schematically shown by broken arrows D.

As shown in FIG. 8, speaker device 2 is different from speaker device 1 according to the embodiment in that speaker device 2 further includes second horn 25.

Second horn 25 emits second sound S2 output from second loudspeaker 20 in the X-axis plus direction. In the example shown in FIG. 8, second horn 25 emits, in the X-axis plus direction, second sound S2 output from second loudspeaker 20 and diffused by diffuser 23. Second horn 25 is provided to surround second loudspeaker 20 and diffuser 23. As viewed from the X-axis plus direction, the center of second loudspeaker 20, the center of second horn 25, and the center of diffuser 23 coincide with each other. Second horn 25 has a cylindrical shape, and is attached to the end portion of third housing 31 that is on the X-axis plus direction side so as to have openings in the X-axis plus direction and the X-axis minus direction (or in other words, in the front-back direction) and surround a space in diffuser 23 that is on the X-axis plus direction side. The opening of second horn 25 that is on the X-axis minus direction side is closed by diffuser 23 and third housing 31, and the opening of second horn 25 that is on the X-axis plus direction side is open. The axial direction of second horn 25 coincides with the X-axis plus direction. As viewed from the X-axis plus direction, second horn 25 is flared outward more than first horn 15.

Second horn 25 includes inner surface 26 that becomes gradually wider toward the X-axis plus direction. In the example shown in FIG. 8, the angle formed by the normal line of inner surface 26 and the X-axis plus direction is constant. The angle formed by the normal line of inner surface 26 and the X-axis plus direction may be changed in two stages or continuously. The angle formed by the normal line of inner surface 26 and the X-axis plus direction (the average angle in the case where the angle is changed) is smaller than, for example, predetermined angle θ. Also, the angle formed by the normal line of inner surface 26 and the X-axis plus direction is smaller than, for example, the angle formed by the normal line of inner surface 16 of first horn 15 and the X-axis plus direction.

The shape of second horn 25 is not limited to a cylindrical shape, and may be a flat-plate shape. In this case, second horn 25 includes an opening in a center portion of second horn 25 as viewed from above. Second horn 25 is attached to the end portion of third housing 31 that is on the X-axis plus direction side such that, for example, the opening is closed by diffuser 23 and third housing 31.

In the case of the presence of second horn 25, it is possible to prevent second sound S2 from traveling in the X-axis minus direction relative to second loudspeaker 2, which increases the amount of second sound S2 that travels in the X-axis plus direction side, and effectively transmits second sound S2 to second position P2.

Also, in the case of the absence of second horn 25, second sound S2 travels directly in the X-axis minus direction of speaker device 2, which increases the path difference between first sound S1 and second sound S2 that travel in the X-axis minus direction of speaker device 2, and thus, on the X-axis minus direction side of speaker device 2, first sound S1 is unlikely to be cancelled out by second sound S2. In contrast, in the case of the presence of second horn 25, the traveling path of second sound S2 that travels in the X-axis minus direction of speaker device 2 is extended. Accordingly, the path difference between first sound S1 and second sound S2 that travel in the X-axis minus direction of speaker device 2 is reduced as compared with that in the case of the absence of second horn 25. For this reason, even on the X-axis minus direction side of speaker device 2, first sound S1 is likely to be cancelled out by second sound S2.

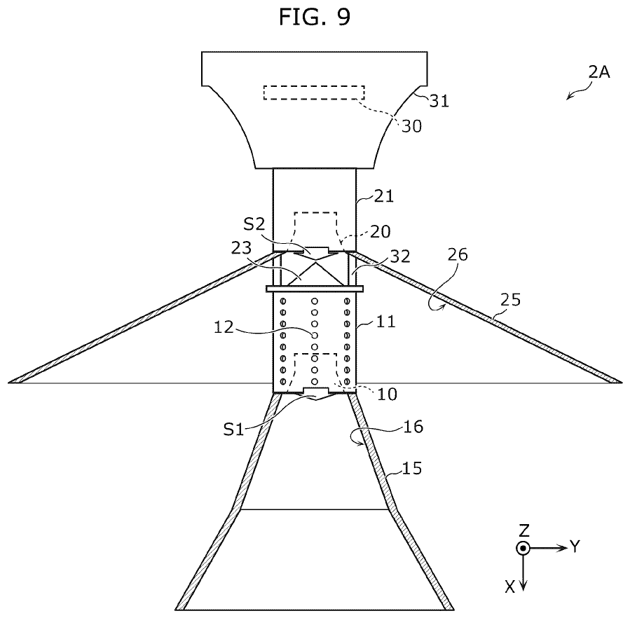

In speaker device 2, second loudspeaker 20 outputs second sound S2 in the X-axis minus direction. However, second loudspeaker 20 may output second sound S2 in the X-axis plus direction. FIG. 9 is a plan view showing one example of an external appearance of another speaker device 2A according to the present variation. FIG. 9 shows the external appearance of speaker device 2A as viewed from above (from the Z-axis plus direction). In FIG. 9, for the sake of the description, first horn 15 and second horn 25 are shown in a cross section taken in half along the XY plane. There is actually the other half of first horn 15 and second horn 25 on the front side (the Z-axis plus direction side) of FIG. 9. Also, in FIG. 9, first loudspeaker 10, second loudspeaker 20, and substrate 30 that are housed respectively in first housing 11, second housing 21, and third housing 31 are indicated by broken lines.

As shown in FIG. 9, in speaker device 2A, second loudspeaker 20, second housing 21, and diffuser 23 are arranged in the X-axis direction in an order reverse to that in speaker device 2.

Specifically, in speaker device 2A, second loudspeaker 20 outputs second sound S2 in the X-axis plus direction. Second loudspeaker 20 is provided at the end portion of second housing 21 that is on the X-axis plus direction side.

Also, in speaker device 2A, second housing 21 is connected to the end portion of first housing 11 that is on the X-axis minus direction side via connecting member 32. An opening for installing second loudspeaker 20 is formed at the end portion of second housing 21 that is on the X-axis plus direction side, and the opening is closed by second loudspeaker 20. Also, the end portion of second housing 21 that is on the X-axis minus direction side is closed by a plate-shaped member.

Also, in speaker device 2A, diffuser 23 is provided on the output direction side of second sound S2 relative to second loudspeaker 20, or in other words, diffuser 23 is provided to face second loudspeaker 20 on the X-axis plus direction side relative to second loudspeaker 20. Also, diffuser 23 is fixed to the end portion of first housing 11 that is on the X-axis minus direction side.

In speaker device 2A, second horn 25 is provided on the X-axis plus direction side relative to second loudspeaker 20. Second horn 25 has a cylindrical shape, and is attached to the end portion of second housing 21 that is on the X-axis plus direction side so as to have openings in the X-axis plus direction and the X-axis minus direction (or in other words, in the front-back direction) and surround a space in diffuser 23 that is on the X-axis plus direction side. The opening of second horn 25 that is on the X-axis minus direction side is closed by second loudspeaker 20 and second housing 21, and the opening of second horn 25 that is on the X-axis plus direction side is open.

With speaker device 2A as well, as a result of second horn 25 being provided, it is possible to obtain the same advantageous effects as those of speaker device 2.

Speaker device 2A may be configured without second horn 25. That is, in speaker device 1 according to the embodiment, second loudspeaker 20, second housing 21, and diffuser 23 may be arranged in a reverse order, and second loudspeaker 20 may output second sound S2 in the X-axis plus direction.

### [Variation 2]

Next, Variation 2 of the embodiment will be described. In the description of Variation 2 given below, differences from the embodiment and Variation 1 will be mainly described, and a description of similarities will be omitted or simplified.

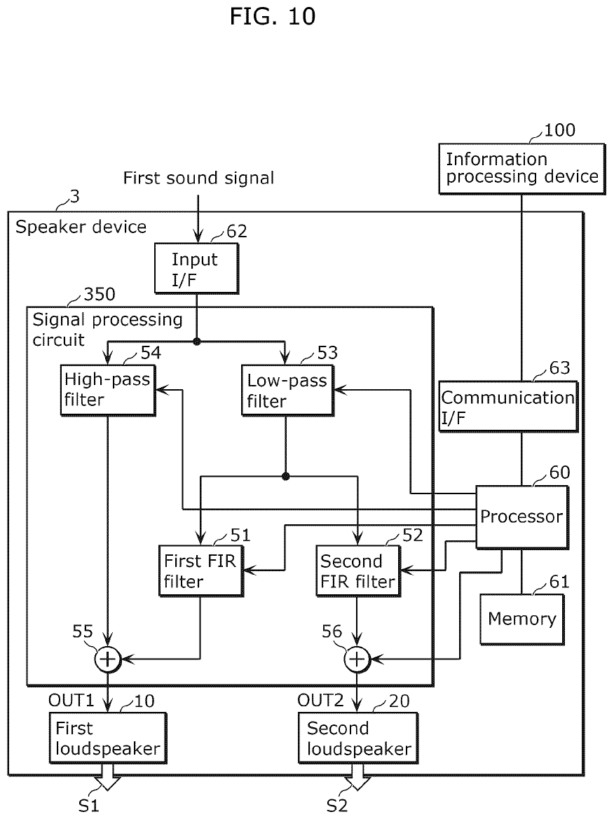

FIG. 10 is a block diagram showing one example of a functional configuration of speaker device 3 according to the present variation.

As shown in FIG. 10, speaker device 3 is different from speaker device 1 according to the embodiment in that speaker device 3 includes, instead of signal processing circuit 50, signal processing circuit 350 that includes adder 56 added to the same configuration as signal processing circuit 50. The external appearance of speaker device 3 may be, for example, any one of the external appearances of the speaker devices described in the embodiment and Variation 1.

Adder 56 generates and outputs second output signal OUT2 by adding the output of second FIR filter 52 and a second sound signal that indicates a masking sound. The masking sound is a sound that is unrelated to the first sound signal, and may be, for example, an environmental sound such as the sound of a river. For example, audio data of the masking sound is stored in memory 61, and processor 60 generates the second sound signal based on the audio data, and inputs the generated second sound signal into adder 56. Speaker device 3 may further include an input interface that receives the second sound signal, and an external second sound signal may be input into adder 56 via the input interface. Also, the second sound signal may be subjected to signal processing performed by signal processing circuit 350 or a different signal processing circuit before the second sound signal is input into adder 56.

In speaker device 3, second output signal OUT2 has been generated by adding the second sound signal to the output of second FIR filter 52, and thus second sound S2 that is based on second output signal OUT2 includes, in addition to the cancellation sound for cancelling out first sound S1, the masking sound that is unrelated to the sound that needs to be emitted from speaker device 3 and to be heard. At second position P2, the sound pressure of the sound that is based on the first sound signal is reduced to be lower than that at first position P1, but it is difficult to reduce the sound pressure to zero. For this reason, in the case where speaker device 3 is installed in a quiet environment, even at second position P2, the sound that is based on the first sound signal may be heard at a level that bothers people. With speaker device 3, the masking sound is heard around speaker device 3, and thus even in the case where speaker device 3 is installed in a quiet environment, with the masking sound, it is possible to make the sound that is based on the first sound signal difficult to be heard at second position P2.

### [Variation 3]

Next, Variation 3 of the embodiment will be described. In the description of Variation 3 given below, differences from the embodiment and Variations 1 and 2 will be mainly described, and a description of similarities will be omitted or simplified.

In the present variation, an example will be described in which the speaker device further includes a sound absorber. Although details will be described below, as a result of the sound absorber absorbing sound, the sound pressure can be reduced on the X-axis minus direction side of the speaker device where first sound S1 is unlikely to be cancelled out by second sound S2, and thus the directivity can be further enhanced.

First, a configuration of the speaker device according to the present variation will be described.

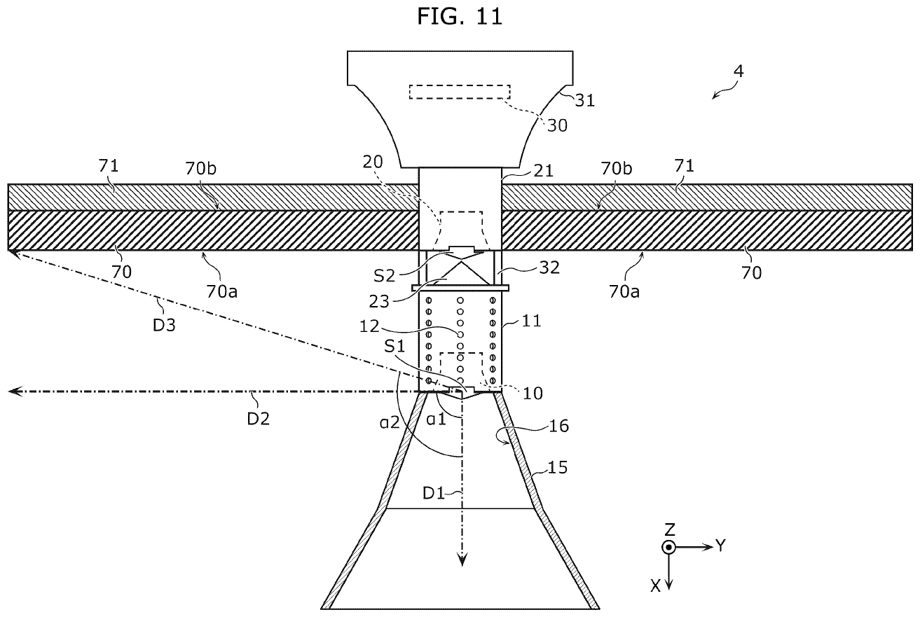

FIG. 11 is a plan view showing one example of an external appearance of speaker device 4 according to the present variation. FIG. 11 shows the external appearance of speaker device 4 as viewed from above (from the Z-axis plus direction). In FIG. 11, for the sake of the description, first horn 15, sound absorber 70, and sound reflector 71 are shown in a cross section taken in half along the XY plane. However, there is actually the other half of first horn 15, sound absorber 70, and sound reflector 71 on the front side (the Z-axis plus direction side) of FIG. 11. Also, in FIG. 11, first loudspeaker 10, second loudspeaker 20, and substrate 30 that are respectively housed in first housing 11, second housing 21, and third housing 31 are indicated by broken lines.

As shown in FIG. 11, speaker device 4 is different from another speaker device 2A according to Variation 1 of the embodiment in that speaker device 4 does not include second horn 25 and speaker device 4 further includes sound absorber 70 and sound reflector 71. Speaker device 4 does not necessarily need to include sound reflector 71.

Sound absorber 70 is a plate-shaped member that absorbs first sound S1 and second sound S2 that travel in the X-axis minus direction. Sound absorber 70 is provided to include a portion that surrounds first loudspeaker 10 and second loudspeaker 20, as viewed from the X-axis plus direction. As viewed from the X-axis plus direction, sound absorber 70 is flared outward more than first loudspeaker 10 and second loudspeaker 20.

As viewed from the X-axis plus direction, the center of sound absorber 70 coincides with, for example, the center of first loudspeaker 10. The outer shape of sound absorber 70 as viewed from the X-axis plus direction is, for example, a rectangular shape, but may be any other shape such as a circular shape or an elliptical shape.

Sound absorber 70 includes, as two opposing surfaces in the thickness direction of sound absorber 70, first surface 70a that is located on the X-axis plus direction side and second surface 70b that is located on the X-axis minus direction side relative to first surface 70a. In the example shown in FIG. 11, first surface 70a and second surface 70b are perpendicular to the thickness direction of sound absorber 70 and parallel to each other.

In the X-axis direction, at least a portion of sound absorber 70 is located at the same position as the outlet position of second sound S2 in speaker device 4, or a position on the X-axis minus direction side relative to the outlet position. In the case where second horn 25 is not provided as in speaker device 4, the outlet position of second sound S2 is the sound output position of second loudspeaker 20. In the example shown in FIG. 11, first surface 70a is located at the same position as the sound output position of second loudspeaker 20 in the X-axis direction. For this reason, entire sound absorber 70 is located at the same position as the sound output position of second loudspeaker 20, or on the X-axis minus direction side relative to the sound output position of second loudspeaker 20. First surface 70a may be located on the X-axis minus direction side relative to the sound output position of second loudspeaker 20 in the X-axis direction.

Sound absorber 70 is attached to a side surface of second housing 21. In the example shown in FIG. 11, a through hole is formed at a center portion of sound absorber 70, and sound absorber 70 and second housing 21 are fixed with second housing 21 being placed in the through hole. Sound absorber 70 may be attached directly to second housing 21, or may be attached directly to second housing 21 via an attachment member (not shown). In this case, sound absorber 70 and second housing 21 are not necessarily in contact with each other.

In speaker device 4, predetermined angle θ for defining second position P2 is, for example, an angle between first angle α1 and second angle α2, first angle α1 being an angle formed by the X-axis plus direction and an extension direction of first surface 70a as viewed in a cross section taken along a plane parallel to the X-axis plus direction that passes through the center of first loudspeaker 10, and second angle α2 being an angle formed by the X-axis plus direction and a direction that connects the sound output position of first loudspeaker 10 and an end portion of first surface 70a (or in other words, an outer periphery of first surface 70a) as viewed in the above cross section. With this configuration, the sound pressure of the sound that travels in the direction extending along sound absorber 70 is reduced, and thus a sound that travels around on the X-axis minus direction side is unlikely to occur, and thus the sound pressure of sound on the X-axis minus direction side relative to sound absorber 70 can be effectively reduced. Also, the size reduction of sound absorber 70 can be achieved. The plane in above cross section is also a plane where first position P1 and second position P2 are located. In FIG. 11, for the sake of the description, an arrow that indicates the X-axis plus direction (D1 shown in the diagram) that is the output direction of first sound S1 from first loudspeaker 10, an arrow that indicates the extension direction of first surface 70a (D2 shown in the diagram), and an arrow that indicates the direction (D3 shown in the diagram) that connects the sound output position of first loudspeaker 10 and the end portion of first surface 70a are illustrated starting from the sound output position of first loudspeaker 10. For this reason, in FIG. 11, an arrow that indicates the extension direction of first surface 70a is translated in parallel from the position of first surface 70a to the sound output position of first loudspeaker 10. The expression “predetermined angle θ is an angle between first angle α1 and second angle α2” encompasses the case where predetermined angle θ is the same angle as first angle α1 and the case where predetermined angle θ is the same angle as second angle α2. Predetermined angle θ may be the same angle as first angle α1.

The difference between first angle α1 and second angle α2 is, for example, 20 degrees or less. The difference between first angle α1 and second angle α2 may be 10 degrees or less.

Also, in the example shown in FIG. 11, sound absorber 70 has a flat-plate shape, and first angle α1 is set to 90 degrees. With this configuration, when a portion of the sound emitted from speaker device 4 is reflected by sound absorber 70 and sound reflector 71, it is possible to effectively suppress disturbance of the sound pressure characteristics of the sound emitted from speaker device 4. First angle α1 does not necessarily need to be set to 90 degrees, and may be set to, for example, 45 degrees or more and 135 degrees or less.

There is no particular limitation on the sound absorbing material for constituting sound absorber 70. Sound absorber 70 may include, for example, a Helmholtz resonator or a foamed body that has continuous cells such as a sponge. Sound absorber 70 may be made of a composite material composed of a plurality of types of sound absorbing materials. For example, in sound absorber 70, the plate-shaped Helmholtz resonator and the plate-shaped foamed body may be stacked. As a result of sound absorber 70 including a Helmholtz resonator, it is possible to absorb the sounds in the mid-low sound range in which the directivity is unlikely to be enhanced by first horn 15.

Sound reflector 71 is a member that is in the shape of a plate and reflects, out of first sound S1 and second sound S2 that have entered sound absorber 70, a component that was not absorbed by sound absorber 70. As a result of the component being reflected, on the X-axis minus direction of speaker device 4, the sound pressure can be further reduced, and the directivity can be enhanced.

Sound reflector 71 is provided on the X-axis minus direction side relative to sound absorber 70. Sound reflector 71 is provided in second surface 70b of sound absorber 70. As viewed from the X-axis plus direction, the contour of sound reflector 71 coincides with, for example, that of sound absorber 70. As viewed from the X-axis plus direction, sound absorber 70 entirely overlaps sound reflector 71.

Sound reflector 71 is attached to the side surface of second housing 21 together with sound absorber 70. In the example shown in FIG. 11, a through hole is formed at a center portion of sound reflector 71, and sound reflector 71 and second housing 21 are fixed with second housing 21 being placed in the through hole.

Sound reflector 71 is, for example, a member that is in the shape of a plate and made using a metal or a resin. Sound reflector 71 may be formed into a unitary body with sound absorber 70.

Next, measurement results of the directivity of sound emitted from speaker device 4 will be described.

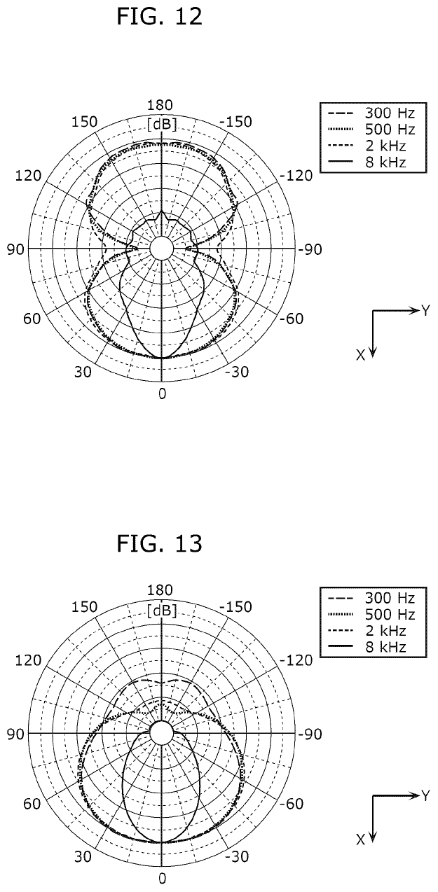

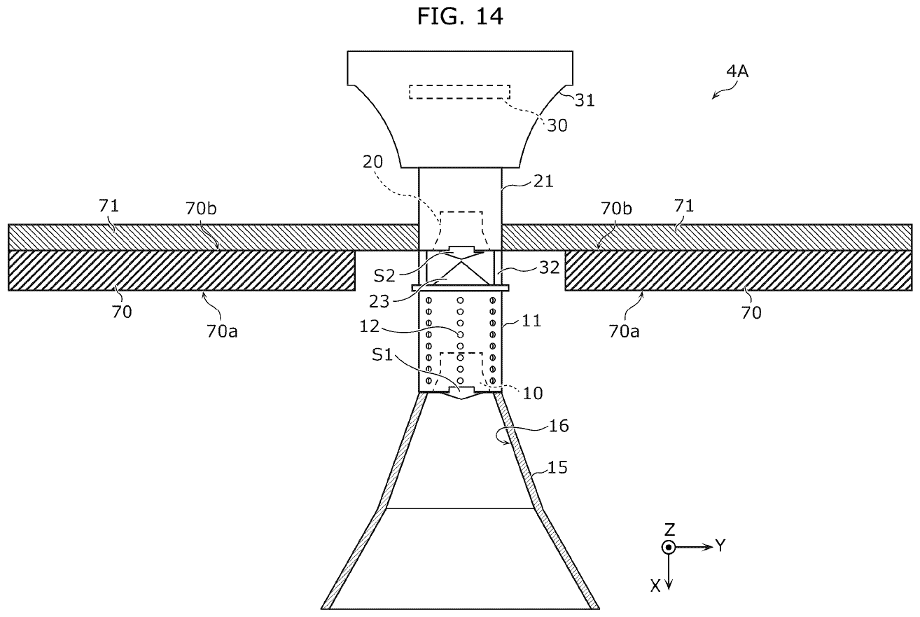

FIG. 12 is a graph showing one example of a directivity of sound emitted from a speaker device configured by removing sound absorber 70 and sound reflector 71 from speaker device 4 according to the present variation. FIG. 13 is a graph showing one example of a directivity of sound emitted from speaker device 4 according to the present variation. FIGS. 12 and 13 show sound pressure (unit: dB) based on the sound pressure at first position P1. Also, in FIGS. 12 and 13, the sound pressures of sounds at 300 Hz, 500 Hz, 2 kHz, and 8 kHz are shown. In the speaker device used to measure the sounds shown in FIG. 12, predetermined angle θ is set to 90 degrees. In speaker device 4 used to measure the sound shown in FIG. 13, predetermined angle θ and first angle α1 are set to 90 degrees, and second angle α2 is set to 95 degrees.

As shown in FIG. 12, even with the speaker device without sound absorber 70 and sound reflector 71, the sound pressures of the sounds in all frequencies are lowered in directions that each form an angle of 90 degrees with respect to the X-axis plus direction relative to first loudspeaker 10, and the directivity for sounds in a wide frequency range can be enhanced, as compared with that of the speaker device according to the comparative example shown in FIG. 6.

As shown in FIG. 13, in the sounds emitted from speaker device 4 according to the present variation, the sound pressures of the sounds in all frequencies are lowered on the X-axis minus direction side relative to first loudspeaker 10, as compared with those of the sounds emitted from first loudspeaker 10 shown in FIG. 12. This is due to the following three effects. The first effect is that first sound S1 and second sound S2 that travel in the X-axis minus direction are absorbed by sound absorber 70. The second effect is that, as a result of predetermined angle θ being set to 90 degrees that is the same angle as first angle α1, the sound pressure of the sound that travels in the direction extending along sound absorber 70 is reduced, and a sound that travels around on the X-axis minus direction side is unlikely to occur. The third effect is that, out of first sound S1 and second sound S2 that have entered sound absorber 70 by sound reflector 71, a component that was not absorbed by sound absorber 70 is reflected.

Also, as a result of first angle α1 being set to 90 degrees, disturbance is not generated in the sound pressure characteristics of the sound emitted in the X-axis plus direction relative to first loudspeaker 10. This is because, out of first sound S1 and second sound S2 that have entered sound absorber 70, a component that was reflected by sound reflector 71 without being absorbed by sound absorber 70 overlaps the characteristics of the sound emitted in the X-axis plus direction.

As described above, it can be seen that, as a result of sound absorber 70 being provided in speaker device 4, the sound pressure is reduced on the X-axis minus direction side of speaker device 4, and thus the directivity can be enhanced.

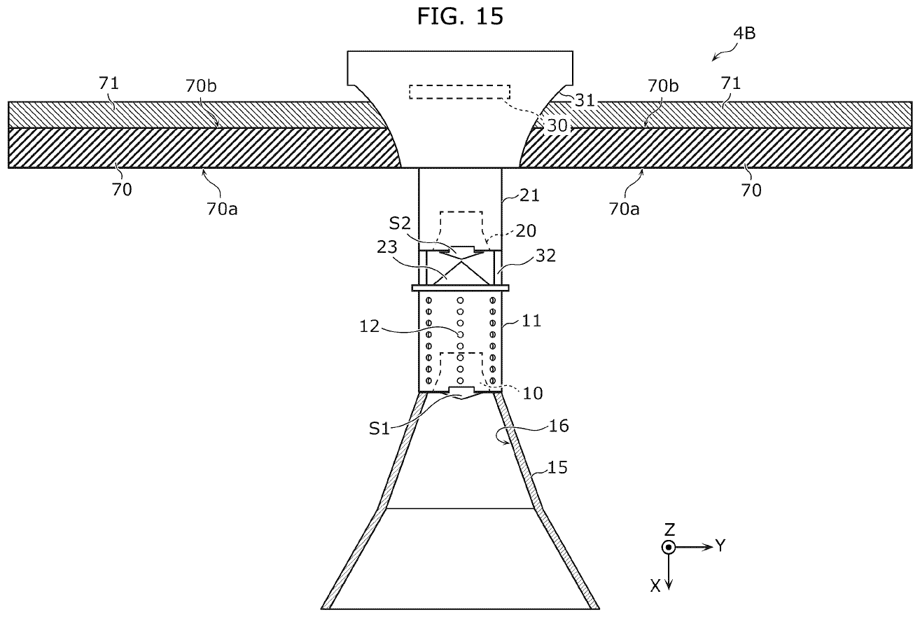

The position at which sound absorber 70 and sound reflector 71 are attached is not limited to that of the example shown in FIG. 11. FIGS. 14 to 16 are plan views showing examples of the external appearance of another speaker devices 4A to 4C according to the present variation. In FIGS. 14 to 16, for the sake of the description, first horn 15, second horn 25 (only in FIG. 16), sound absorber 70, and sound reflector 71 are shown in a cross section taken in half along the XY plane. However, there is actually the other half of first horn 15, second horn 25 (only in FIG. 16), sound absorber 70, and sound reflector 71 on the front side (the Z-axis plus direction side) of FIG. 14. Also, in FIGS. 14 to 16, first loudspeaker 10, second loudspeaker 20, and substrate 30 that are respectively housed in first housing 11, second housing 21, and third housing 31 are indicated by broken lines.

In speaker device 4A shown in FIG. 14, sound absorber 70 is attached to a side surface of second housing 21 via sound reflector 71. In speaker device 4A, in the X-axis direction, first surface 70a is located on the X-axis plus direction relative to the sound output position of second loudspeaker 20, and second surface 70b is located at the same position as the sound output position of second loudspeaker 20. In the X-axis direction, second surface 70b may be located on the X-axis minus direction relative to the sound output position of second loudspeaker 20. Also, in speaker device 4A, a gap for second sound S2 to travel in the X-axis plus direction is formed between second housing 21 and sound absorber 70 as viewed from the X-axis plus direction.

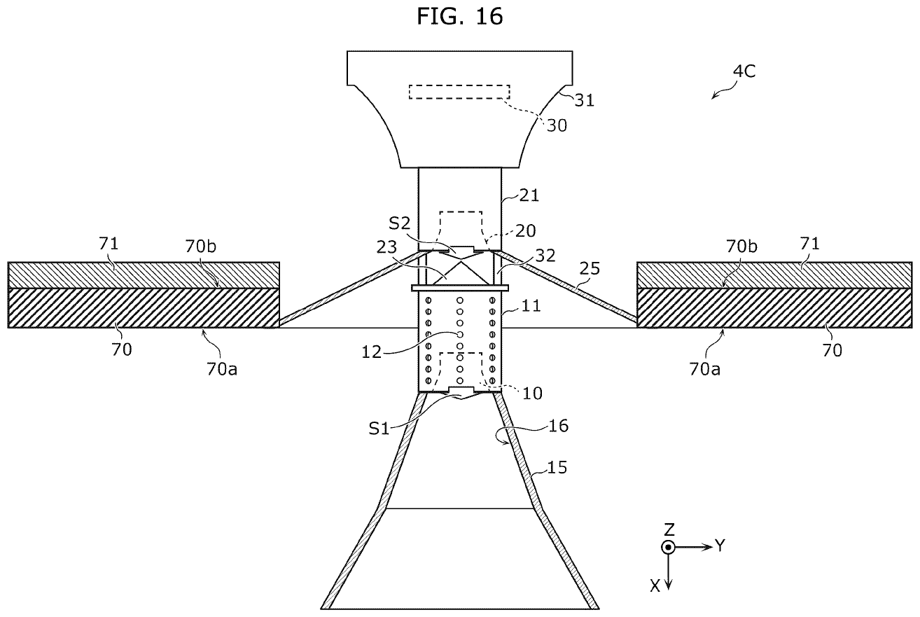

In speaker device 4B shown in FIG. 15, sound absorber 70 is attached to third housing 31 together with sound reflector 71. In the example shown in FIG. 15, sound absorber 70 is attached to a side surface of third housing 31 together with sound reflector 71. At least one of sound absorber 70 or sound reflector 71 may be attached to a rear surface of third housing 31 (a surface that is on the X-axis minus direction side). Also, at least one of sound absorber 70 or sound reflector 71 may be attached to an attachment portion of the ceiling, the wall, or the like where speaker device 4B is installed.

In speaker device 4C shown in FIG. 16, second horn 25 is provided, and sound absorber 70 is attached to second horn 25. That is, speaker device 4C has a configuration obtained by adding sound absorber 70 and sound reflector 71 to speaker device 2A. In the example shown in FIG. 16, sound absorber 70 is attached to an end portion of second horn 25 that is on the X-axis plus direction side. In speaker device 4C, sound absorber 70 is provided to include a portion that surrounds second horn 25, and is flared outward more than second horn 25 as viewed from the X-axis plus direction. Sound absorber 70 may be attached to second horn 25 via sound reflector 71. Alternatively, sound absorber 70 may be attached to a portion other than the end portion of second horn 25. Instead of second horn 25, sound absorber 70 may be attached to second housing 21, third housing 31, or an attachment portion of the ceiling, the wall, or the like where speaker device 4C is installed.

Also, in speaker device 4C, in the X-axis direction, at least a portion of sound absorber 70 is located at the same position as the outlet position of second sound S2 in speaker device 4C, or a position on the X-axis minus direction side relative to the outlet position. In the case where second horn 25 is provided as in speaker device 4C, the outlet position of second sound S2 is the front end position of second horn 25 that is on the X-axis plus direction side. In the example shown in FIG. 15, entire sound absorber 70 is located on the X-axis minus direction side relative to the outlet position of second sound S2 in speaker device 4C.

In the examples given above, examples were described in which sound absorber 70 and sound reflector 71 are provided in a configuration obtained by removing second horn 25 from speaker device 2A, or the configuration of speaker device 2A. However, sound absorber 70 and sound reflector 71 may be provided in any of speaker devices 1, 2, and 3 described above.

### Other Embodiments

As described above, the embodiment (including variations) has been described as examples of the technique disclosed in the present application. However, the technique disclosed herein is not limited thereto, and is also applicable to embodiments obtained by making modifications, replacements, additions, omissions, and the like as appropriate. Also, it is also possible to make a new embodiment by combining the structural elements of the embodiment described above.

Also, for example, in the embodiment described above, first housing 11 includes a plurality of through holes 12, but the configuration is not limited thereto. First housing 11 may not include the plurality of through holes 12, and the inner space of first housing 11 may be a closed space.

Also, for example, in the embodiment described above, at least one of first loudspeaker 10 or second loudspeaker 20 may be composed of a plurality of loudspeakers.

Also, for example, in the embodiment described above, the filter characteristics of first FIR filter 51 and second FIR filter 52 are determined by performing the adaptive filter design. However, the configuration is not limited thereto. The filter characteristics of first FIR filter 51 and second FIR filter 52 may be determined using a method other than the adaptive filter design. For example, the filter characteristics of first FIR filter 51 and second FIR filter 52 may be designed using a simulation or the like.

Also, for example, in the embodiment described above, signal processing circuits 50 and 350 include low-pass filter 53 and high-pass filter 54, but the configuration is not limited thereto. For example, the first sound signal may be input directly into first FIR filter 51 and second FIR filter 52.

Also, in the embodiment described above, processing performed by a specific processing circuit such as a processor may be performed by a different processing circuit. In addition, the order of a plurality of processing operations may be changed. The plurality of processing operations may be performed in parallel. In addition, the processor that executes the above-described program may be a single processor or a plurality of processors. That is, centralized processing may be performed, or distributed processing may be performed.

Also, generic or specific aspects of the present invention may be implemented by a system, a device, a method, an integrated circuit, a computer program or a computer readable recording medium such as a CD-ROM, or may be implemented by any combination of a system, a device, a method, an integrated circuit, a computer program and a recording medium. For example, the present disclosure may be implemented as a loudspeaker system that includes a speaker device, an information processing device, and the like. The loudspeaker system may be implemented by a plurality of devices, or may be implemented as a single device. Also, in the case where the loudspeaker system is implemented by a plurality of devices, the structural elements of the loudspeaker system may be assigned to the plurality of devices in any way.

The present disclosure also encompasses other embodiments obtained by making various modifications that can be conceived by a person having ordinary skill in the art to the above embodiment as well as embodiments implemented by any combination of the structural elements and the functions of the above embodiment without departing from the scope of the one aspect of the present disclosure.

### INDUSTRIAL APPLICABILITY

The present disclosure is applicable to a speaker device or the like that has directivity.

### REFERENCE SIGNS LIST

1, 2, 2A, 3, 4, 4A, 4B, 4C speaker device
10 first loudspeaker
11 first housing
12 through hole
15 first horn
16, 26 inner surface
20 second loudspeaker
21 second housing
23 diffuser
25 second horn
30 substrate
31 third housing
32 connecting member
50, 350 signal processing circuit
51 first FIR filter
52 second FIR filter
53 low-pass filter
54 high-pass filter
55, 56 adder
60 processor
61 memory
62 input interface
63 communication interface
70 sound absorber
70a first surface
70b second surface
71 sound reflector
100 information processing device
111, 112 microphone
OUT1 first output signal
OUT2 second output signal
P1 first position
P2 second position
S1 first sound
S2 second sound

1. A speaker device comprising:
a signal processing circuit that performs signal processing on a first sound signal that is input, and generates a first output signal and a second output signal;
a first loudspeaker that outputs a first sound that is based on the first output signal in a first direction;
a first horn that emits, in the first direction, the first sound output from the first loudspeaker; and
a second loudspeaker that is provided at a position in a second direction relative to the first loudspeaker, and outputs a second sound that is based on the second output signal, the second direction being a direction opposite to the first direction,
wherein the signal processing circuit includes a first filter and a second filter that perform the signal processing on, out of the first sound signal, a signal in at least a portion of frequency bands,
the first output signal is generated based on an output of the first filter,
the second output signal is generated based on an output of the second filter,
the first filter and the second filter have filter characteristics for adjusting a phase and an amplitude per frequency of the signal in at least the portion of the frequency bands out of the first sound signal to cause a sound pressure of a sound based on the first sound signal at a second position to be lower than a sound pressure of the sound based on the first sound signal at a first position by a predetermined value or more as a result of the first sound and the second sound overlapping each other,
the first position is located in front of the first loudspeaker in the first direction, and
the second position is located in a direction at a predetermined angle relative to the first speaker, the predetermined angle being an angle formed with respect to the first direction.

2. The speaker device according to claim 1,
wherein the signal processing circuit includes a low-pass filter into which the first sound signal is input, and
the first filter and the second filter perform the signal processing on an output of the low-pass filter.

3. The speaker device according to claim 1, comprising:
a housing that is cylindrical in shape and whose axial direction coincides with the first direction,
wherein the first loudspeaker is provided at an end portion of the housing in the first direction, and
a plurality of through holes are provided in a circumferential side wall of the housing.

4. The speaker device according to claim 1,
wherein the second loudspeaker outputs the second sound in the second direction.

5. The speaker device according to claim 1, comprising:
a diffuser that diffuses the second sound output from the second loudspeaker.

6. The speaker device according to claim 1, comprising:
a second horn that emits, in the first direction, the second sound output from the second loudspeaker.

7. The speaker device according to claim 1,
wherein the signal processing circuit includes an adder that generates the second output signal by adding a second sound signal that indicates a masking sound to the output of the second filter.

8. The speaker device according to claim 1, comprising:
a sound absorber that is in a shape of a plate and provided to include a portion that surrounds the first loudspeaker and the second loudspeaker as viewed from the first direction,
wherein the sound absorber absorbs the first sound and the second sound that travel in the second direction, and
the predetermined angle is an angle between a first angle and a second angle, the first angle being an angle formed by the first direction and an extension direction of a surface of the sound absorber in the first direction as viewed in a cross section taken along a plane parallel to the first direction that passes through a center of the first loudspeaker, the second angle being an angle formed by the first direction and a direction that connects a sound output position of the first loudspeaker and an end portion of the surface of the sound absorber as viewed in the cross section.

9. The speaker device according to claim 8, comprising:
a sound reflector that is in a shape of a plate and provided at a position in the second direction relative to the sound absorber.

10. The speaker device according to claim 8,
wherein the first angle is 90 degrees.
